(19) United States
(12) Patent Application Publication
(10) Pub. No.: US 2025/0148665 A1
(43) Pub. Date: May 8, 2025

(54) DISPLAY CONTROL DEVICE, COMPUTING SYSTEM, AND DISPLAY CONTROL METHOD

(71) Applicant: NEC Corporation, Tokyo (JP)

(72) Inventors: Tomohiro YAMAJI, Tokyo (JP); Ryoji Miyazaki, Tokyo (JP); Yuki Susa, Tokyo (JP)

(73) Assignee: NEC Corporation, Tokyo (JP)

(21) Appl. No.: 18/910,241

(22) Filed: Oct. 9, 2024

(30) Foreign Application Priority Data
Nov. 7, 2023 (JP) 2023-189927

(51) Int. Cl. G06T 11/20; G06N 10/20

(52) U.S. Cl. CPC G06T 11/206; G06N 10/20

(57) ABSTRACT

A display control device generates data for displaying at least three variable nodes, wherein each variable node indicates a state of each of at least three quantum bit, parity node indicating a parity of the at least three quantum bits, and edges coupling between each variable nodes and the parity node.

This application is based upon and claims the benefit of priority from Japanese patent application No. 2023-189927, filed on Nov. 7, 2023, the disclosure of which is incorporated herein in its entirety by reference.

### TECHNICAL FIELD

The present disclosure relates to a display control device, a computing system, a display control method, a display method, and a program.

### BACKGROUND ART

Problems addressed by quantum computers are sometimes represented as graphs. For example, U.S. Patent Application Publication No. 2021/0263643 discloses a technique for formulating a combinatorial optimization problem to be solved through quantum annealing, which is a type of quantum computing, as an Ising problem and displaying the resulting program as a graph. In the technique disclosed in U.S. Patent Application Publication No. 2021/0263643, Ising spins are represented by nodes of a graph, and the state of the Ising spins is represented by the color of the icon representing the node. Furthermore, U.S. Patent Application Publication No. 2021/0263643 discloses a technique in which two coupled nodes are connected by a solid line edge, and couplings that are not used in the annealing of the target problem are represented by a dashed line edge.

### SUMMARY

It is preferable that the coupling of not only two quantum bits but also three or more qubits can be represented.

An example of an object of the present disclosure is to provide a display control device, a computing system, a display control method, a display method, and a program capable of solving the above problem.

According to a first example aspect of the present disclosure, a display control device includes a display control means that generates data for displaying variable nodes each indicating a state of at least three quantum bits, parity nodes indicating a parity of the at least three quantum bits, and edges coupling the variable nodes and the parity nodes.

According to a second example aspect of the present disclosure, a computing system includes: a computing means that performs a computation on a target problem serving as a target problem addressed by a quantum computer; and a display control means, wherein the display control means generates data for displaying variable nodes each indicating a state of a plurality of quantum bits of the target problem, parity nodes indicating a parity of at least three quantum bits among the plurality of quantum bits, and edges coupling the variable nodes each indicating a state of at least three quantum bits and the parity nodes.

According to a third example aspect of the present disclosure, a display control method includes a computer-implemented step of generating data for displaying variable nodes each indicating a state of at least three quantum bits, parity nodes indicating a parity of the at least three quantum bits, and edges coupling the variable nodes and the parity nodes.

According to a fourth example aspect of the present disclosure, a display method includes a step, by means of a display device, of displaying variable nodes each indicating a state of at least three quantum bits, parity nodes indicating a parity of the at least three quantum bits, and edges coupling the variable nodes and the parity nodes.

According to a fifth example aspect of the present disclosure, a program causes a computer to execute a step of performing control for displaying variable nodes each indicating a state of at least three quantum bits, parity nodes indicating a parity of the at least three quantum bits, and edges coupling the variable nodes and the parity nodes.

According to the present disclosure, it is possible to represent the coupling of three or more quantum bits.

### BRIEF DESCRIPTION OF THE DRAWINGS

FIG. 1 is a diagram showing a configuration example of a computing system according to at least one of the example embodiments.

FIG. 2 is a diagram showing a configuration example of a computing device according to at least one of the example embodiments.

FIG. 3 is a diagram showing a configuration example of a terminal device according to at least one of the example embodiments.

FIG. 4 is a diagram showing an example of a logical problem that is converted into a physical problem by a problem conversion unit according to at least one of the example embodiments.

FIG. 5 is a diagram showing an example of a physical problem obtained through a conversion from a logical problem performed by a problem conversion unit according to at least one of the example embodiments.

FIG. 6 is a diagram showing an example of a graph display screen by a display unit according to at least one of the example embodiments.

FIG. 7 is a diagram showing another example of the graph display screen by the display unit according to at least one of the example embodiments.

FIG. 8 is a diagram showing an example of the distinction in the representation methods of logical bits according to at least one of the example embodiments.

FIG. 9 is a diagram showing an example of the method of representing a physical bit associated with a plurality of logical bits according to at least one of the example embodiments.

FIG. 10 is a diagram showing a first specific example of the method of representing a physical bit associated with a plurality of logical bits according to at least one of the example embodiments.

FIG. 11 is a diagram showing a second specific example of the method of representing a physical bit associated with a plurality of logical bits according to at least one of the example embodiments.

FIG. 12 is a diagram showing a third specific example of the method of representing a physical bit associated with a plurality of logical bits according to at least one of the example embodiments.

FIG. 13 is a diagram showing an example of a processing procedure performed by the terminal device according to at least one of the example embodiments.

FIG. 14 is a diagram showing a configuration example of a display control device according to at least one of the example embodiments.

FIG. 15 is a diagram showing a configuration example of the computing system according to at least one of example embodiments.

FIG. 16 is a diagram showing an example of a processing procedure in a display control method according to at least one of the example embodiments.

FIG. 17 is a diagram showing an example of a processing procedure in a display method according to at least one of the example embodiments.

FIG. 18 is a diagram showing an example of a processing procedure in a computing method according to at least one of the example embodiments.

FIG. 19 is a schematic block diagram showing a configuration of a computer according to at least one of example embodiments.

### EXAMPLE EMBODIMENT

Hereinafter, example embodiments of the present disclosure will be described, however, the present disclosure within the scope of the claims is not limited by the following example embodiments. Furthermore, not all the combinations of features described in the example embodiments are essential for the solving means of the disclosure.

### First Example Embodiment

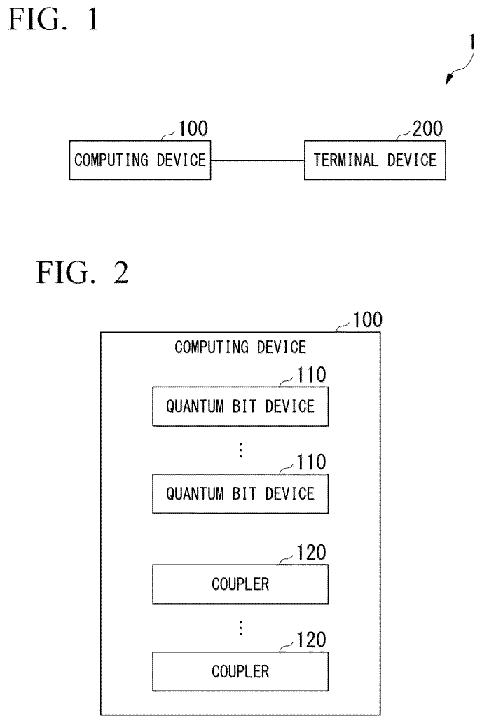

FIG. 1 is a diagram showing a configuration example of a computing system according to at least one of the example embodiments. In the configuration shown in FIG. 1, a computing system 1 includes a computing device 100 and a terminal device 200.

The computing system 1 performs quantum computing or pseudo-quantum computing. Quantum computing here refers to solving problems represented using quantum bits (qubits) using a quantum computer. A quantum bit is a variable that can assume two states and a superposition of those two states. A problem represented using quantum bits is also referred to as a target problem to be addressed by a quantum computer, or simply as the target problem.

Here, pseudo-quantum computing refers to simulating the behavior of a quantum computer using a classical computer (von Neumann computer).

The computing system 1 can be used for quantum annealing or simulated annealing. However, the quantum computing or pseudo-quantum computing performed by the computing system 1 is not limited to quantum annealing or simulated annealing. The computing system 1 can also be used for general quantum computing or pseudo-quantum computing with state display and coupling.

The computing device 100 solves the target problem according to the control of the terminal device 200. For example, in a case where the target problem is a combinatorial optimization problem that is subject to quantum annealing, the computing device 100 searches for a solution that maximizes the indicator value shown by the evaluation function in the optimization problem (indicating a good evaluation) using quantum annealing or simulated annealing. The target problem here may be represented by an Ising model. The evaluation function here may be represented as an Ising Hamiltonian (Hamiltonian in the Ising model).

The computing device 100 may be configured using a quantum computer and perform quantum computing. Alternatively, the computing device 100 may be configured using a classical computer and perform pseudo-quantum computing.

The terminal device 200 controls the computation performed by the computing device 100. Furthermore, the terminal device 200 generates and displays information indicating the target problem. The terminal device 200 corresponds to an example of a display control device.

The following description takes an example in which the terminal device 200 generates and displays a graph showing a target problem.

The terminal device 200 may be configured, using a classical computer. Furthermore, a device for controlling the computation performed by the computing device 100 and a device for displaying the target problem in a graph may be configured as separate devices. The device for controlling the computation performed by the computing device 100 may be configured as a part of the computing device 100. Alternatively, the computing device 100 and the terminal device 200 may be configured as an integrated device.

FIG. 2 is a diagram showing a configuration example of the computing device 100. FIG. 2 shows an example in which the computing device 100 is configured using a quantum computer. The following description takes an example in which the computing device 100 is used for quantum annealing. However, as mentioned above, the computing device 100 can also be used for quantum computing or quasi-quantum computing other than quantum annealing.

In the configuration shown in FIG. 2, the computing device 100 includes multiple quantum bit devices 110 and multiple couplers 120.

The quantum bit device 110 is a device that represents a quantum bit. As mentioned above regarding quantum bits, the quantum bit device 110 can assume two states and a superposition of those two states.

The quantum bit device 110 is not limited to any particular type of device. For example, the quantum bit device 110 may be configured using a JPO (Josephson Parametric Oscillator), but is not limited to this.

A control parameter value based on an evaluation function for a target problem is set in the quantum bit device 110. For example, in a quantum bit device 110, a control parameter value is set based on the coefficient of a single-variable term determined by the variable that the quantum bit device 110 indicates. The variable that the quantum bit device 110 indicates here is a variable in the evaluation function that indicates the quantum bit indicated by the quantum bit device 110.

The method of setting the control parameter values for the quantum bit device 110 is not limited to a particular method. For example, the control parameter value may be set in the quantum bit device 110 by inputting microwaves having a frequency corresponding to the control parameter value to the quantum bit device 110. However, the disclosure is not limited to this example.

A coupler 120 controls the interaction between the quantum bits. Specifically, a control parameter value indicating the coupling strength (strength of interaction) of the quantum bits is set in the coupler 120. The coupler 120 controls the quantum bit device 110 so that the quantum bit device 110 takes a state according to the setting value for the coupler 120 itself.

The interaction between quantum bits is also referred to as quantum bit coupling. The interaction of multiple quantum bits is also described as the quantum bits being coupled with each other or simply as the quantum bits being coupled.

The coupling strengths of the quantum bits are set based on an evaluation function for the target problem. For example, in the case of a two-body coupling in which two quantum bits interact, the coupling strength is set according to the coefficient values of the two-variable terms representing those two quantum bits. In a case where a target problem is transformed to be implemented on a quantum computer, the coupling strengths of the quantum bits are set based on an evaluation function in the transformed target problem.

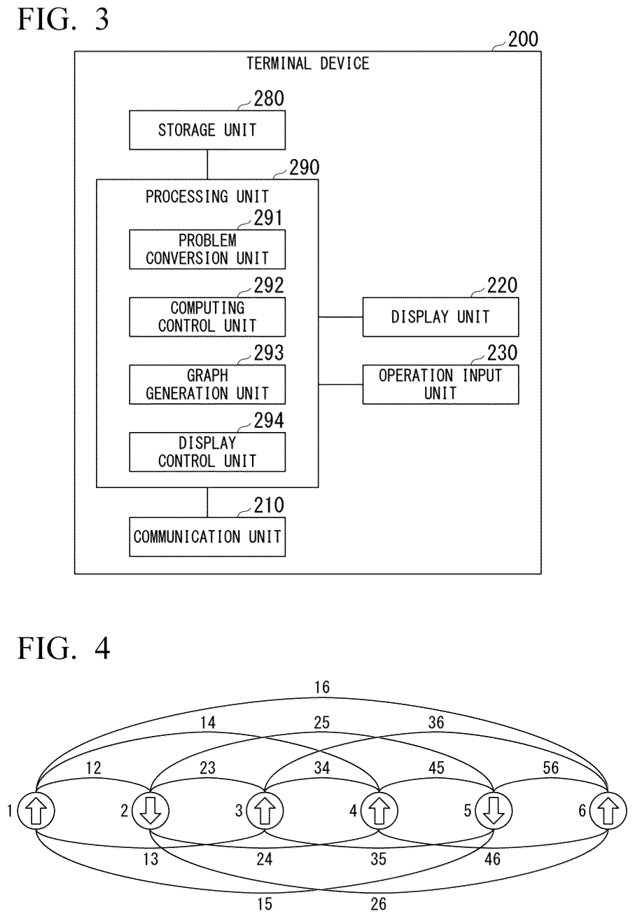

FIG. 3 is a diagram showing a configuration example of a terminal device 200. In the configuration shown in FIG. 3, the terminal device 200 includes a communication unit 210, a display unit 220, an operation input unit 230, a storage unit 280, and a processing unit 290. The processing unit 290 includes a problem conversion unit 291, a computing control unit 292, a graph generation unit 293, and a display control unit 294.

As described above, the terminal device 200 corresponds to an example of the display control device. However, the display unit 220 and the operation input unit 230 are not essential for the display control device.

The display unit 220 and the operation input unit 230 may be configured as external components of the terminal device 200.

The communication unit 210 communicates with other devices. For example, the communication unit 210 transmits the setting values of the control parameters for quantum bit devices 110 and the setting values of the control parameters for couplers 120, to the computing device 100. In addition, the communication unit 210 receives the measurement values of the state of each quantum bit device 110 from the computing device 100.

The display unit 220 includes a display screen such as a liquid crystal panel or a light emitting diode (LED) panel, and displays various types of images. In particular, the display unit 220 displays a graph showing the target problem.

The display unit 220 corresponds to an example of the display means.

The display unit 220 may be configured as a device installed remotely from the processing unit 290 and connected via a network. In such a case, the display control unit 294 may transmit image data or data that is the basis for image generation and is encoded in Hyper Text Markup Language (HTML) or the like, to the display unit 220 via the network.

The operation input unit 230 includes input devices such as a keyboard and a mouse, and accepts user operations. For example, the operation input unit 230 may receive user operations for inputting various setting values related to quantum computing, such as the number of iterations of a solution search in quantum annealing. The operation input unit 230 may be configured as a device installed remotely from the processing unit 290 and connected via a network.

The storage unit 280 stores various types of data. The storage unit 280 is configured using a storage device included in the terminal device 200.

For example, the storage unit 280 stores a graph showing the target problem.

The processing unit 290 controls each unit of the terminal device 200 and executes various processes. Functions of the processing unit 290 may be executed by a Central Processing Unit (CPU) included in the terminal device 200 reading out a program from the storage unit 280 and executing the program.

The problem conversion unit 291 converts a target problem into a problem in a format that can be implemented in the computing device 100. A target problem before conversion is also referred to as a logical problem. The quantum bits used in a logic problem are also referred to as logical bits. A target problem after conversion is also referred to as a physical problem. The quantum bits used in a physical problem are also referred to as physical bits.

FIG. 4 is a diagram showing an example of a logical problem that is converted into a physical problem by a problem conversion unit 291. In the example of FIG. 4, the logical problem is shown as a graph containing nodes numbered 1 through 6 and edges connecting two nodes. Each node represents a logical bit. Each edge represents a two-body coupling of logical bits. Here, the coupling of N quantum bits is referred to as an N-body coupling. Here, N is an integer where N≥2.

FIG. 4 shows an example of a case where the logical bits are fully coupled through two-body couplings. An edge assigned with numbers ij indicates a two-body coupling of a logical bit represented by a node numbered i and a logical bit represented by a node numbered j. Here, i is an integer where 1≤i<6, and j is an integer where i<j≤6.

The process of converting a problem represented by full coupling, as shown in the example of FIG. 4, into a problem represented by sparse coupling and implementing it on a quantum computer is being performed. In particular, in a case where there are a large number of quantum bits, then in full couplings, the total number of couplings increases in the order of the square of the number of quantum bits N, making it difficult to directly implement on hardware. The number of couplings here refers to the number of interacting quantum bits. Accordingly, the process of converting a problem represented by full coupling into a problem represented by sparse coupling and implementing it on a quantum computer is being performed. The process of converting a problem represented by full coupling into a problem represented by sparse coupling and implementing it on a quantum computer is also described as embedding logical bits of full coupling into physical bits of sparse coupling.

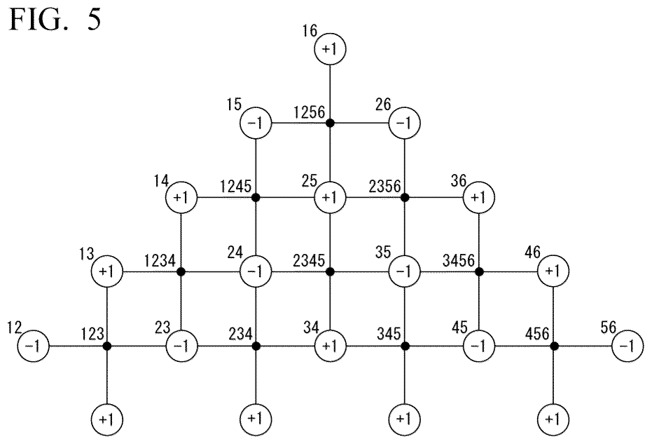

FIG. 5 is a diagram showing an example of a physical problem obtained through a conversion from a logical problem performed by the problem conversion unit 291. FIG. 5 shows an example of a sparse coupling model based on the LHZ model, which is a conversion of the full coupling model in the example of FIG. 4.

In the example of FIG. 5, white circles (◯) with two-digit numbers such as “12”, “13”, . . . , and so on represent physical bits. White circles with no two-digit numbers represent physical bits that take a constant value.

In the example of FIG. 5, the value of each physical bit is indicated as “+1” or “−1”, but the value of the quantum bit processed by the computing system 1 is not limited to this example. For example, the two states of a quantum bit in a target problem may be represented as “0” and “1”.

In the example of FIG. 5, the product of two logical bits in the example of FIG. 4 is shown as one physical bit. For example, the physical bit numbered 12 in the example of FIG. 5 represents the product of the logical bit numbered 1 and the logical bit numbered 2 in the example of FIG. 4.

In the implementation of the physical problem of the example of FIG. 5 on the computing device 100, the physical bits are represented by the quantum bit devices 110.

Moreover, in the example of FIG. 5, black circles (e) with four-digit numbers such as “1234”, “1245”, . . . , and so on, and black circles with three-digit numbers such as “123”, “234”, . . . , and so on all indicate four-body couplings.

In these four-body couplings, the physical bits are controlled to ensure that the parity of the values of the four physical bits is even parity (even numbered parity). In this case, parity is a concept that indicates whether a number is even or odd.

In a case where the values of the physical bits are represented by “+1” or “−1”, the parity is calculated as the product of the values of the coupled physical bits. In this case, even parity corresponds to the value of the product of the physical bit values being “+1”. Furthermore, in the present specification, the parity of multiple bit values may be referred to simply as “bit parity”. The term “bit” as used here includes logical bits, physical bits, and quantum bits.

Even in a case where the values of individual bits are not determined and are in a superposition state, the parity may still be determined. The term “parity of bits” includes such cases. An example of this, as will be described later, is in a case where there are eight possible combinations of four bits that result in odd parity, and the value of the four bits is a superposition of these eight possible patterns.

In a case where the value of a physical bit is represented by “+1” or “−1”, a “+1” for the physical bit indicates that the two logical bits represented by that physical bit are oriented in the same direction. A “−1” for the physical bit indicates that the two logical bits represented by that physical bit are oriented in opposite directions.

If an odd number of four physical bits in a four-body coupling have a value of “1”, it becomes impossible to remap the physical bits to logical bits.

For example, consider a case where, of four physical bits numbered 13, 14, 23, and 24, the values of the three physical bits numbered 13, 14, and 23 are “+1” and the value of the physical bit numbered 24 is “−1”. In such a case, the four logical bits numbered 1, 2, 3, and 4 have the same orientation because the physical bits numbered 13, 14, and 23 have a value of “+1”. On the other hand, since the value of the physical bit numbered 24 has a value of “−1”, the logical bit numbered 2 and the logical bit numbered 4 have opposite directions, which contradicts the condition that these physical bits have the same direction.

Thus, in a case where the parity in the four-body coupling is odd, a contradiction occurs in the values of the logical bits, and the physical bits cannot be remapped into logical bits. Therefore, by controlling the physical bits to ensure that the parity in the four-body coupling is even parity, it is possible to obtain a physical bit value that can specify the value of the logical bit.

In the example of FIG. 5, the physical bits without numbers in the upper left (the four physical bits in the bottom row) represent fixed bits with a value fixed at “+1”.

Moreover, four-body couplings with three-digit numbers can be considered as three-body couplings with even parity (even numbered parity). In the example of FIG. 5, only four-body couplers are used as couplers, and the even parity constraint of the three-body couplers is realized by providing a fixed bit with a value fixed at “+1”.

In the implementation of the physical problem of the example of FIG. 5 in the computing device 100, the computing device 100 includes a four-body coupler as the coupler 120, and the function of the four-body coupling is performed by the coupler 120.

As in the example in FIG. 5, a multi-body coupling may appear in a physical problem. The multi-body coupling referred to here is a coupling of three or more bodies (that is, a coupling of three or more quantum bits).

A multi-body coupling may also appear in a logic problem. For example, consider a logical problem in quantum annealing where the Hamiltonian H is represented as shown in Expression (1).

$$H = {\sum }_{i = 1}^{N - 3} {\sum }_{j = i + 1}^{N - 2} {\sum }_{k = j + 1}^{N - 1} {{\sum }^{N}}_{l = j + 1} {a}_{i , j , k , l} {x}_{i} {x}_{j} {x}_{k} {x}_{l} + {\sum }_{i = 1}^{N - 2} {\sum }_{j = i + 1}^{N - 1} {{\sum }^{N}}_{k = j + 1} {a}_{i , j , k} {x}_{i} {x}_{j} {x}_{k} + {\sum }_{i = 1}^{N - 1} {{\sum }^{N}}_{j = i + 1} {a}_{i , j} {x}_{i} {x}_{j} + {{\sum }^{N}}_{i = 1} {a}_{i} {x}_{i} + A \qquad ( 1 )$$

xᵢ denotes a logical bit.
N is an integer indicating the number of logical bits xᵢ and satisfies N≥4.
a_{i,j,k,l} is the coefficient of the four-variable term “a_{i,j,k,l}xᵢxⱼxₖxₗ”.
a_{i,j,k} is the coefficient of the three-variable term “a_{i,j,k}xᵢxⱼxₖ”.
a_{i,j} is the coefficient of the two-variable term “a_{i,j}xᵢxⱼ”.
aᵢ is the coefficient of the one-variable term “aᵢxᵢ”.
A is a constant term.

The product of the four variables, “xᵢxⱼxₖxₗ” in the four-variable term “a_{i,j,k,l}xᵢxⱼxₖxₗ” is expressed as a four-body coupling. The product of three variables, “xᵢxⱼxₖ” in the three-variable term “a_{i,j,k}xᵢxⱼxₖ” is expressed as a three-body coupling. The product of the two variables, “xᵢxⱼ”, in the two-variable term “a_{i,j}xᵢxⱼ” is expressed as a two-body bond. As mentioned above, the parity of multiple variables corresponds to the product of the variables. According to the computing system 1, even a problem involving product terms of three or more variables (a problem involving multi-body coupling) can be expressed using parity.

The computing control unit 292 controls the computation performed by the computing device 100. For example, the computing control unit 292 transmits the control parameter values for the quantum bit devices 110 and the control parameter values for the couplers 120 to the computing device 100 via the communication unit 210.

The graph generation unit 293 generates a graph showing a target problem. The graph generation unit 293 may output both a graph showing a logical problem and a graph showing a physical problem. Alternatively, the graph generation unit 293 may generate a graph only showing one of a logical problem and a physical problem.

The display control unit 294 controls the display unit 220 to display various images. In particular, the display control unit 294 causes the display unit 220 to display the graph generated by the graph generation unit 293. Specifically, the display control unit 294 generates data for displaying a graph. The display control unit 294 then outputs the generated data to the display unit 220, thereby controlling the display unit 220 to display the graph. The data for displaying the graph may be image data, or may be data that is encoded in HTML language or the like and serves as the basis for image generation.

The display control unit 294 corresponds to an example of the display control means.

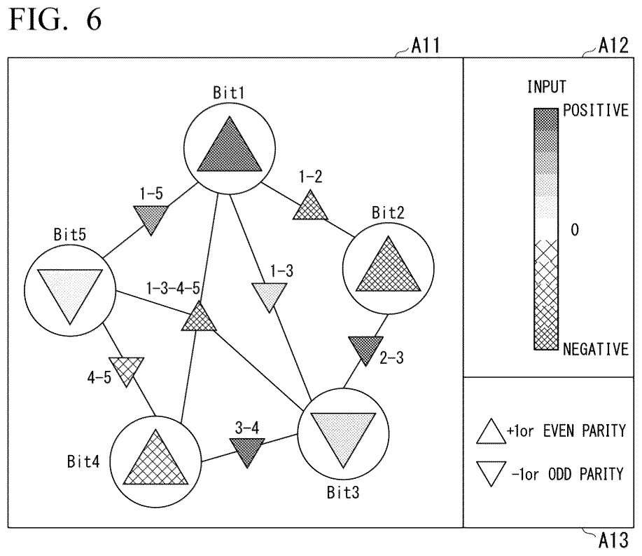

FIG. 6 is a diagram showing an example of a graph display screen by the display unit 220. The display screen shown in FIG. 6 includes regions A11, A12, and A13. The region A11 is a display region for a graph. The region A12 is a display region for the legend of input values. The region A13 is a display region for the legend of output values.

The graph in the region A11 includes variable nodes, parity nodes, and edges. The variable nodes are nodes that represent quantum bits. The parity nodes are nodes that represent the parity of the quantum bits that are coupled to each other. The edges connect each variable node, representing quantum bits that are coupled with each other, to the parity nodes, which represent the parity of these quantum bits.

The variable nodes are represented by symbols featuring an upward triangle (Δ) or a downward triangle (∇), each enclosed in a white circle (◯). The parity nodes are represented by an upward triangle (Δ) or a downward triangle (∇). The edges are indicated by straight lines.

Moreover, the graph in FIG. 6 shows the input and output values of each node.

The input value to a variable node is the setting value for that variable node. For example, the input value to a variable node may be the setting value of a control parameter for a quantum bit device 110. Alternatively, the input value to a variable node may be the value of a coefficient of a one-variable term of the variable represented by the variable node in an evaluation function in quantum computing. For example, in Equation (1) above, the input value to the variable node representing variable x₁ may be the value of coefficient a₁.

The input value to a parity node is the setting value for that parity node. For example, the input value to a parity node may be the setting value of a control parameter for a coupler 120. Alternatively, the input value to a parity node may be the value of a coefficient of a term in the product of variables representing quantum bits that are coupled to each other in an evaluation function in quantum computing. For example, in the above Expression (1), where the variables xᵢ, xⱼ, and xₖ represent quantum bits that are coupled with each other, the input to the parity node representing the parity of these variables xᵢ, xⱼ, and xₖ may be the value of the coefficient a_{i,j,k} of the term a_{i,j,k}xᵢxⱼxₖ of the product xᵢxⱼxₖ of the variables.

Both the input values to the variable nodes and the input values to the parity nodes are shown according to the legend shown in the region A12.

The output value of a variable node is the value of the quantum bit represented by the variable node. The output value of a variable node in a graph representing a physical problem is the observed value of the physical bit represented by the variable node. The output value of a variable node of a graph showing a logical problem is the value of a logical bit calculated from the output value of a node of the graph showing the physical problem in conversion from a physical problem to a logical problem.

The output value of a parity node is the value of the parity represented by the parity node. For example, in the graph in FIG. 6, the value of the parity node labeled “1-3-4-5” is the parity value between the variable node labeled “Bit1”, the variable node labeled “Bit3”, the variable node labeled “Bit4”, and the variable node labeled “Bit5”.

The numbers indicated for each variable node, such as “Bit1”, “Bit2”, . . . , and so on are also referred to as bit numbers. The bit number can be used as an identification number to identify a variable node.

The parity can take either an odd parity value or an even parity value.

Where a variable node takes a value of 0 or 1, if the number of variable nodes taking the value 1 is odd, this corresponds to odd parity, and is indicated by an output value of 1. Moreover, if the number of variable nodes taking the value 1 is even, this corresponds to even parity, and is indicated by an output value of 1.

Where a variable node takes a value of +1 or −1, if the number of variable nodes taking the value −1 is odd, this corresponds to odd parity, and is indicated by an output value of −1. Moreover, if the number of variable nodes taking the value −1 is even, this corresponds to even parity, and is indicated by an output value of +1.

The graph generation unit 293 may generate a graph in which both the setting values for the variable nodes and the setting values for the parity nodes are represented by color, shading, or a combination thereof. For example, the graph generation unit 293 may generate a graph in which positive set values are shown in red and negative set values in blue where the larger the set value (absolute value) the darker the color.

However, the method of representing the setting values for the nodes (input values to the nodes) in the graph generated by the graph generation unit 293 is not limited to a specific method.

In the example of FIG. 6, both the output values to the variable nodes and the output values to the parity nodes are shown according to the legend shown in the region A13.

In the example of FIG. 6, the output value of a variable node takes either +1 or −1. The output value of a parity node also takes either +1 (even parity) or −1 (odd parity). +1 is represented by an upward triangle (Δ) and −1 is represented by a downward triangle (∇).

However, the method of representing the values for the nodes (output values of the nodes) in the graph generated by the graph generation unit 293 is not limited to a specific method. For example, the graph generation unit 293 may generate a graph in which the values of variable nodes and the values of parity nodes are shown in different geometric orientations, such as representing the values of variable nodes in the orientation of a triangle and the values of parity nodes in the orientation of a pentagon.

Moreover, the graph generation unit 293 may generate a graph in which different types of couplings are represented by different geometric shapes, such as representing two-body couplings by triangles and three-body couplings by pentagons.

The graph generation unit 293 may determine the value of each node based on the most frequently occurring solution among multiple solutions obtained by the computing device 100 repeatedly calculating solutions using quantum computing, and display the values on the graph. Alternatively, the graph generation unit 293 may determine the value of each node based on the distribution of values for each node across multiple solutions obtained by the computing device 100 repeatedly calculating solutions using quantum computing, and display the values on a graph.

Here, in order to evaluate the operation of a quantum computer, it is necessary to examine the correspondence between the input and output values of the quantum computer. However, due to the conversion from a logical problem to a physical problem, it is thought to be challenging to examine the correspondence between input and output values. This difficulty is especially pronounced in problems involving a large number of quantum bits, where examining the correspondence between input and output values is particularly challenging.

In contrast, it is expected that by displaying a graph as shown in FIG. 6, the display unit 220 will help the user (the viewer of the graph) grasp the correspondence between input and output values.

For instance, where the target problem involves quantum annealing and values of quantum bits are represented as +1 or −1, if, among the variable and parity nodes, there are many red downward triangles indicating a positive input value with an output value of −1 or blue upward triangles indicating a negative input value with an output value of +1, the value of the Hamiltonian will be small, which can be evaluated as correct behavior.

Thus, by displaying a graph such as that exemplified in FIG. 6 on the display unit 220, the user (the person who views the graph) can visually grasp the relationship between the input and output values. For example, understanding the relationship between these input and output values is expected to be useful during the calibration of computing system 1, and in a case where checking the computation results from computing device 100.

Moreover, in a case where there is redundancy in physical bits in the correspondence between logical bits and physical bits, it is possible that the physical bits might assume a combination of values that cannot be converted into a value of the logical bits. Thus, if contradictions arise during the conversion of physical bit values to logical bit values, it may be necessary to revise the physical problem. For example, this may involve checking for unintended couplings (such as whether any couplings that were not intended in the design of the target problem have been introduced into the physical problem).

In contrast, displaying a graph such as that exemplified in FIG. 6 on the display unit 220 is expected to be useful in a case where revising the physical problem. For example, displaying a graph such as that exemplified in FIG. 6 on the display unit 220 is expected to be useful in discovering couplers 120 in which the coupling setting value (parity node setting value) is inconsistent with the state of the quantum bits coupled to each other, and in discovering unintended couplings.

The display unit 220 may also be configured to display the parity of sets of quantum bits that are not coupled in the problem. For example, in the example of FIG. 6, the display unit 220 may display the parity between the value of the variable node labeled “Bit2” and the value of the variable node labeled “Bit4”. The display unit 220 may also be configured to automatically display the parity of sets of quantum bits for which no coupling is set in the problem, or display the parity according to a user instruction.

Furthermore, in a case where three or more quantum bit devices 110 are connected to a coupler 120 that has been detected as an inconsistent coupler 120, a graph such as that exemplified in FIG. 6 is expected to be useful in revising the inputs to those quantum bit devices 110, or revising the coupling relationships of those quantum bit devices 110.

For example, in the graph shown in FIG. 6, the input to the parity node labeled “1-3-4-5” results in odd parity. In contrast, the values of the four variable nodes labeled “Bit1”, “Bit3”, “Bit4”, and “Bit5” coupled to this parity node are two +1 and two −1, and the parity output of this parity node is even parity. Accordingly, at the parity node labeled “1-3-4-5”, a contradiction occurs between the input and the output.

One measure to resolve this contradiction is to reconsider the input values of the four variable nodes labeled “Bit1”, “Bit3”, “Bit4”, and “Bit5”. Thus, a countermeasure should be taken such that among the four variable bits, either one is +1 and three are −1, or three are +1 and one is −1.

Here, the number of possible combinations for these four variable bit values, where one bit is +1 and three bits are −1, or where three bits are +1 and one bit is −1, is relatively high, with ₄C₃₊₄C₁=8 combinations. Thus, in the case of a constraint on three or more bits of parity the number of solutions that satisfy the constraint is significantly greater than that in the case of a constraint on a two-bit coupling relationship, providing more options for redesigning the physical problem. In response to this, the computing system 1 displays inputs and outputs of the bit group that is of interest in the physical problem in a graphical format that allows the user to visually view at a glance the inputs and outputs of the bit group, preferably in a freely switchable manner for the user to consider multiple options. This is expected to make it easier for the user (the person viewing the display) to make an appropriate redesign.

Hereinafter, the variable nodes labeled “Bit1”, “Bit2”, “Bit3”, “Bit4”, and “Bit5” will also be referred to simply as Bit1, Bit2, Bit3, Bit4, and Bit5, respectively.

One example of a method for displaying multiple options in a freely switchable manner is, in a case where the user clicks on and selects a parity node of interest with the mouse pointer, then above each variable bit directly connected to the parity node, a combination that satisfies the constraint is displayed with +1 or −1, or an upward triangle (Δ) or downward triangle (∇) is displayed, and the combination changes with each click, and a comprehensive display of solutions is displayed by clicking as many times as there are solutions.

Another example of a method for displaying multiple options in a freely switchable manner is to display a small window that lists all the solutions in a simple tabular format, and in a case where the user clicks on and specifies a solution in the small window with the mouse pointer, a +1 or −1 is displayed above each of the variable bits that are directly connected to the parity node in the corresponding combination.

In this way, even if there are many redesign options, the display unit 220 can display each candidate solution that satisfies the parity constraint on the variable bit that is directly connected to the parity node that the user is focusing on. Even when there are many redesign options, the user can view each of the candidate solutions that satisfy the parity constraint, and can also view the status of other additional constraints that are imposed on the graph structure. This allows the user to switch the display of candidate solutions that satisfy the parity constraints and compare these candidates sequentially.

For example, consider a case where the user is comparing the option of modifying the value of Bit3 with the option of modifying the value of Bit4 among the candidates that result in odd parity for the parity node labeled “1-3-4-5” in the example shown in FIG. 6. The option of modifying the value of Bit3 is to set the values of Bit1, Bit3, Bit4, and Bit5 to +1, +1, +1, and −1, respectively. The option of modifying the value of Bit4 is to set the values of Bit1, Bit3, Bit4, and Bit5 to +1,−1,−1, and −1, respectively.

The option of modifying the value of Bit3 would also improve the two relationships, that is, the input/output relationship of the parity labeled “2-3” (even parity) and the input/output relationship of the parity labeled “3-4” (even parity).

On the other hand, the option of modifying the value of Bit4 would improve the input/output relationship of the parity labeled “3-4” (even parity), but would worsen the input/output relationship of the parity labeled “4-5”. That is to say, the input to the parity labeled “4-5” would be negative (odd parity), while the output would be +1 (even parity).

Therefore, the user can make reference to the display on the display unit 220 and determine that the option of modifying the value of Bit3 is a better option. In such a case, the user can take a remedial measure to change the input of Bit3 to be more strongly positive. The user will be able to easily make such a comparison by making reference to a screen display that can be freely switched.

Combinations of values of variable nodes that are candidates for solutions corresponding to parity may be stored preliminarily in the storage unit 280. For example, the storage unit 280 may preliminarily store combinations of variable node values as data in a tabular format (table format). Then, the display control unit 294 may make reference to the data stored in the storage unit 280 and cause the display unit 220 to switch and display the solution candidates.

For example, the storage unit 280 may preliminarily store eight combination patterns, which are combinations that result in 4-bit odd parity namely (+1, +1, +1,−1), (+1, +1, −1, +1), . . . , (−1, −1, −1, +1), (−1, −1, +1,−1), . . . , and so on, and name these patterns as pattern 1, pattern 2, . . . , and pattern 8.

Then, the display unit 220 may under control of the display control unit 294, assign and display the variable nodes coupled to the parity node on which the user is focusing, in ascending (smallest) bit number order, in order from the left of the pattern 1 (that is, in order from the top of the combination patterns).

Then, according to the control of the display control unit 294, the display unit 220 may, in response to mouse clicks, sequentially switch between patterns from the pattern 2 to the pattern 3, and so on, to thereby perform display in the same manner as the pattern 1 mentioned above. In a case where the pattern 8 is reached, with the next click, the display unit 220 may return to the pattern 1 and perform display according to the control of the display control unit 294.

Moreover, the display unit 220 may also display the above eight patterns as a list on the screen in accordance with the control of the display control unit 294, and display the pattern selected by the user. For example, if the user specifies the pattern 2 with the mouse pointer, the display unit 220 may, according to the control of the display control unit 294, sequentially assign and display the bit numbers in ascending order from the left (+1, +1, −1, +1), in the same manner as that described above.

Furthermore, as will be described later, if the display format of a variable node is changed to simultaneously represent physical bits and their related logical bits, the number of related bits can further increase, which in such a case will provide even more redesign options for physical problems. In contrast, by displaying both the physical problem's graph and the logical problem's graph, the computing system 1 allows the user (the person viewing the display) to visually view the entire input and output, including the logical bits, while considering the redesign of the physical problem. This is expected to facilitate appropriate redesign, and thus the benefits of the present example embodiment are significant.

Furthermore, consider a case where, despite the coupling indicated by the parity node labeled “3-4” in the graph of FIG. 6 being intended to make the value of the variable node labeled “Bit3” the same as that of the variable node labeled “Bit4”, the value of the variable node labeled “Bit3” and the value of the variable node labeled “Bit4” are different (their signs are opposite).

In this case, the coupling indicated by the parity node labeled “3-4” may be considered inappropriate. Therefore, the user may edit the physical problem to exclude the coupling indicated by the parity node labeled “3-4”.

The graph generation unit 293 may also be configured to generate a graph of a target problem before the computing device 100 executes quantum computing. In such a case, the graph generation unit 293 may generate a graph that indicates only the input values to the nodes among the input values to the nodes and the output values of the nodes.

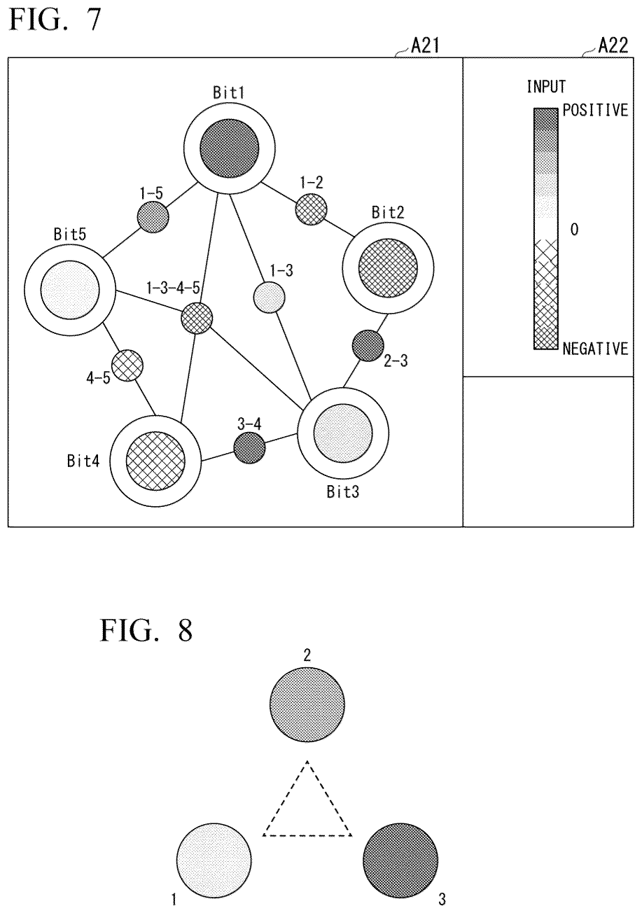

FIG. 7 is a diagram showing another example of a graph display screen by the display unit 220. FIG. 7 shows an example of a graph display showing only input values to nodes among input values to the nodes and the output values of the nodes.

The display screen shown in FIG. 7 includes regions A21 and A22. The region A21 is a display region for a graph. The region A22 is a display region for the legend of input values. Meanwhile, the display screen shown in FIG. 7 does not display the legend for the output values.

Each node is represented using an upward triangle (Δ) or a downward triangle (∇) in the graph of the region A11 of FIG. 6, whereas each node is represented using a circle (◯) in the graph of the region A21 of FIG. 7. Accordingly the output values of the nodes are not displayed in the graph of the region A21 in FIG. 7. In other respects, the graph of the region A21 in FIG. 7 is similar to the graph of the region A11 in FIG. 6.

The graph generation unit 293 may also be configured to generate a graph that indicates the correspondence between logical bits and physical bits.

FIG. 8 is a diagram showing an example of the distinction in the representation methods of logical bits. In the example of FIG. 8, three logical bits are shown, namely, a logical bit numbered 1, a logical bit numbered 2, and a logical bit numbered 3. Assume that these three logic bits are represented in different methods in the graph of the logical problem. For example, the graph generation unit 293 may generate the graph in which the variable nodes of these three logical bits are shown in different colors.

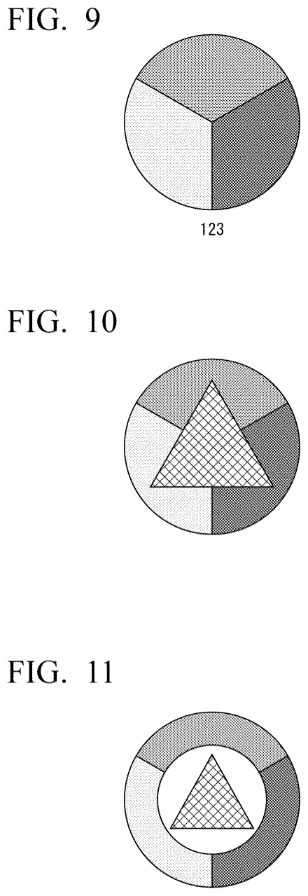

FIG. 9 is a diagram showing an example of the method of representing a physical bit associated with multiple logical bits. In the example of FIG. 9, the physical bit numbered 123 is a physical bit associated with the three logical bits shown in FIG. 8. This physical bit is represented using a combination of the three logical-bit representation methods shown in FIG. 8. For example, the physical bit numbered 123 in the example of FIG. 9 may be represented using each of the colors used to represent the three logical bits shown in FIG. 8.

Correspondence from multiple logical bits to one physical bit may occur in a case where the problem conversion unit 291 converts a logical problem into a physical problem. For example, as described above, the physical bit numbered 12 in the example of FIG. 5 represents the product of the logical bit numbered 1 and the logical bit numbered 2 in the example of FIG. 4.

FIG. 10 is a diagram showing a first specific example of the method of representing a physical bit associated with a plurality of logical bits. FIG. 10 shows the first specific example of the method of representing the physical bit shown in FIG. 9.

FIG. 10 shows the correspondence between logical bits and a physical bit by the method of representing a physical bit in the example of FIG. 9. Furthermore, in FIG. 10, an upward triangle (Δ) is shown inside the circle (◯) indicating the physical bit, similar to the method of representing the variable node in the example of FIG. 6. The upward triangle indicates the output value of this physical bit. Moreover, the input value to this physical bit is also shown by the representation method of the upward triangle.

According to the method of representing a physical bit exemplified in FIG. 10, the correspondence between logical bits and a physical bit, the input values to the physical bit, and the output value of the physical bit can be visually shown.

FIG. 11 is a diagram showing a second specific example of the method of representing a physical bit associated with a plurality of logical bits. FIG. 11 shows the second specific example of the method of representing the physical bit shown in FIG. 9.

FIG. 11 shows the correspondence between logical bits and a physical bit by the method of representing a physical bit in the example of FIG. 9. Furthermore, in FIG. 11, inside the circle (∘) representing the physical bit of the example of FIG. 9, another circle (∘) is shown, and inside the circle, an upward triangle (Δ) is shown, similar to the method of representing the variable nodes in the example of FIG. 6. The region between the circle on the inner side and the upward triangle is filled in white.

In the example of FIG. 11, there is a region filled in white between the symbol representing the correspondence between the quantum bit and physical bit and the symbol indicating the input and output values of the physical bit, that is, a region where no specific representation method is applied. This allows for the visual representation of the correspondence between the logical bits and the physical bit, as well as the input values to and output values from the physical bit, making it easier for the user (the person viewing the display shown in FIG. 11) to recognize the correspondence between the logical bits and the physical bit, along with the input and output values of the physical bit.

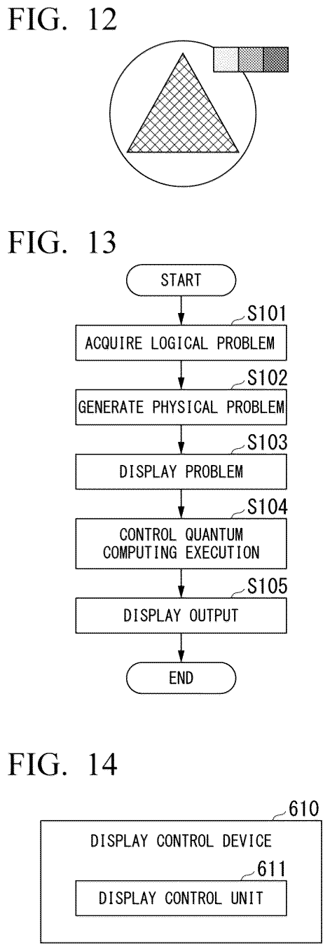

FIG. 12 is a diagram showing a third specific example of the method of representing a physical bit associated with a plurality of logical bits. FIG. 12 shows the third specific example of the method of representing the physical bit shown in FIG. 9.

In FIG. 12, similar to the method of representing variable nodes in the example of FIG. 6, the variable node is represented by a symbol consisting of an upward triangle (Δ) surrounded by a white circle (◯). Furthermore, FIG. 12 shows a symbol that combines three rectangles (▭) that are applied to represent the three logical bits in the example of FIG. 8.

In the example of FIG. 12, symbols indicating the correspondence between the logical bits and the physical bit are provided separately from the symbols representing the input and output values of the physical bit. This allows for the visual representation of the correspondence between the logical bits and the physical bit, as well as the input values to and output values from the physical bit, making it easier for the user (the person viewing the display shown in FIG. 12) to recognize the correspondence between the logical bits and the physical bit, along with the input and output values of the physical bit.

Displaying a graph such as that exemplified in FIG. 6 or FIG. 7 and displaying the correspondence between logical bits and a physical bit such as that exemplified in FIG. 8 to FIG. 12 are expected to allow the user to efficiently evaluate the performance of quantum bits and couplings. This enables the user to examine the method of converting logical bits into physical bits and the formulation of the evaluation function, with the expectation of improving the solution accuracy in quantum computing.

The evaluation of the solution to a physical problem and the correction of the physical problem using the computing system 1 are performed, for example, in the following procedure.

(1) In a case where the terminal device 200 receives a specification for the correspondence between logical bits and a physical bit, the graph generation unit 293 generates a display of the correspondence between the logical bits and the physical bit, as exemplified in FIG. 8 to FIG. 12. The display unit 220 displays the correspondence between the logical bits and the physical bit.

The specification for the correspondence between the logical bits and the physical bit may, for example, involve assigning the product of two logical bits to one physical bit, as shown in the examples of FIG. 4 and FIG. 5. The user may specify the correspondence between the logical bits and the physical bit. Alternatively, data that the terminal device 200 acquires from another device may include a specification of the correspondence between the logical bits and the physical bit.

(2) In a case where the terminal device 200 receives an input of setting values for the nodes of the graph of the logical problem, the problem conversion unit 291 calculates the value of each node of the graph of the physical problem to generate a physical problem. The graph generation unit 293 generates a graph of the physical problem generated by the problem conversion unit 291. The display unit 220 displays the graph of the physical problem generated by the graph generation unit 293.

In such a case, prior to the execution of quantum computing, the display unit 220 displays a graph showing only the input values to the nodes, as exemplified in FIG. 7, among the input and output values of the nodes.

The user may input the setting value for each node in the graph of the logical problem. Alternatively the data that the terminal device 200 acquires from another device may indicate the setting value for each node in the graph of the logical problem.

(3) The computing device 100 repeatedly executes computations for the physical problem. The graph generation unit 293 determines the values for each node in the graph of the physical problem based on the most frequently occurring solutions among those obtained, and then generates the graph of the physical problem. The display unit 220 displays the graph of the physical problem generated by the graph generation unit 293.

For example, the graph generation unit 293 may generate a graph of a physical problem based on the most frequently occurring solution among those obtained. Alternatively the graph generation unit 293 may generate a graph of the physical problem for each of a predetermined number of solutions that have the highest frequency of occurrence among those obtained.

Alternatively the graph generation unit 293 may determine the value of each node based on the distribution of values for each node in the entire obtained solutions, and display the determined value in the graph.

Furthermore, the graph generation unit 293 may also display the probability of the value obtained for each node. For example, if 60,000 solutions show a variable node with a value of +1 and 40,000 solutions show it with a value of −1, the graph generation unit 293 may display the value +1 for that variable node using an upward triangle and generate a graph indicating that this value has a 60% probability.

Moreover, the problem conversion unit 291 calculates the value of each node in the graph of the logical problem based on the value of each node in the graph of the physical problem. The problem conversion unit 291 generates a graph of the logical problem indicating the calculated values of each node. The display unit 220 displays the graph of the logical problem generated by the graph generation unit 293.

(4) The user (the person viewing the graph) makes reference to the graph of the logical problem and the graph of the physical problem to confirm the operation of the coupler 120 in the physical problem. The user also determines whether or not there is an improper coupling or an improper physical bit in the physical problem, and if it is determined that there is an improper coupling or an improper physical bit, detects that coupling or physical bit.

The user may detect unintended couplings as improper coupling. Moreover, if a coupling set as a constraint is not as intended by the user, the coupling may be detected as an improper coupling. Moreover, the user may detect, as improper quantum bits, quantum bits where the control applied to the quantum bits and the effects of that control are reversed, such as with local fields applied to the quantum bits.

If the user detects an improper coupling or an improper physical bit, the user may edit the physical problem to exclude that coupling or physical bit. For example, the user may edit the graph of the physical problem displayed on the display unit 220 by inputting an operation from the operation input unit 230 to thereby edit the physical problem.

The graph generation unit 293 may generate a graph that displays a warning for a variable node or a parity node whose input value and output value are not consistent. Displaying the graph on the display unit 220 can assist the user in editing the physical problem.

For example, the graph generation unit 293 may detect variable nodes or parity nodes where the input and output values lead to an increase in the value of the Hamiltonian, identifying them as nodes where the input and output values are inconsistent.

FIG. 13 is a diagram showing an example of a procedure of processing performed by the terminal device 200.

In the processing of FIG. 13, the terminal device 200 acquires a logical problem (Step S101). For example, the communication unit 210 may receive a logical problem from another device. Alternatively, the operation input unit 230 may accept a user operation for inputting a logical problem.

Next, the problem conversion unit 291 generates a physical problem for implementing the logical problem obtained in Step S101 on a quantum computer (Step S102). The generation of a physical problem performed by the problem conversion unit 291 can be considered as a conversion from a logical problem to a physical problem.

Next, the display unit 220 displays a graph showing the target problem (Step S103). Specifically, the graph generation unit 293 generates a graph that indicates only the input values among the input values to the nodes and the output values of the nodes, such as the graph exemplified in FIG. 7. Then, the display control unit 294 controls the display unit 220 to display the graph generated by the graph generation unit 293. The display unit 220 may display both the graph showing a logical problem and the graph showing a physical problem. Alternatively the display unit 220 may display only one of the graph showing a logical problem and the graph showing the physical problem.

Next, the computing control unit 292 causes the computing device 100 to execute the physical problem generated by the problem conversion unit 291 (Step S104).

Next, the display unit 220 displays a graph showing the target problem and the results of the quantum computing (Step S105). For example, the graph generation unit 293 generates a graph showing the output values of each node by replacing geometric figures that do not indicate a distinction in orientation for each node of the graph generated in Step S103 with geometric figures that indicate a distinction in orientation.

In the examples of FIG. 6 and FIG. 7, the graph generation unit 293 generates a graph showing the output values of each node, as exemplified in FIG. 6, by replacing the circles (◯) that represent the input values in the graph of FIG. 7 with upper triangles (Δ) or lower triangles (∇).

Then, the display control unit 294 controls the display unit 220 to display the graph generated by the graph generation unit 293.

The display unit 220 may display both the graph showing a logical problem and the graph showing a physical problem. Alternatively, the display unit 220 may display only one of the graph showing a logical problem and the graph showing the physical problem.

After Step S105, the terminal device 200 ends the process of FIG. 13.

As described above, the display control unit 294 generates data for displaying variable nodes each indicating the state of at least three quantum bits, parity nodes indicating the parity of the at least three quantum bits, and edges connecting the variable nodes and the parity nodes.

According to the terminal device 200, it is possible to represent the coupling of three or more quantum bits. In particular, according to the terminal device 200, it is possible to represent the coupling of three or more quantum bits by indicating the parities of the three or more quantum bits and the edges linking the quantum bits and the parities.

Moreover, the display control unit 294 generates data for displaying variable nodes each indicating the state of multiple quantum bits in a target problem addressed by a quantum computer. The at least three quantum bits mentioned above are included in the multiple quantum bits mentioned above.

According to the terminal device 200, it is possible to represent the coupling of three or more quantum bits in a case where displaying a problem addressed by a quantum computer. In particular, according to the terminal device 200, in a case where displaying a problem addressed by a quantum computer, it is possible to represent the coupling of three or more quantum bits by indicating the parities of the three or more quantum bits and the edges linking the quantum bits and the parities.

Furthermore, the display control unit 294 generates the data for displaying a graph such that setting values for the variable nodes and setting values for the parity nodes in the target problem are both represented by color, shading, or a combination thereof, and values of quantum bits indicated by the variable nodes and parities indicated by the parity nodes are both represented by the orientation of icons indicating nodes.

According to the terminal device 200, it is possible to display in a graph both the setting value for each node (the input value to each node) and the value of each node (the output value of each node). The user (the person viewing the graph) can relatively easily confirm whether or not the relationship between the input and output of each node is appropriate.

Moreover, the display control unit 294 generates the data for displaying a graph of a physical problem, which is the target problem, converted so as to be implementable in a quantum computer.

According to the terminal device 200, the user (the person viewing the graph) can relatively easily confirm whether or not the relationship between the implementation of the target problem on a quantum computer and the obtained solution is appropriate. In particular, the user can visually grasp not only the coupling of two quantum bits in the implementation of the target problem on a quantum computer, but also the coupling of three or more quantum bits, and confirm whether or not the relationship between the implementation of the target problem on a quantum computer and the obtained solution is appropriate.

Moreover, the display control unit 294 generates the data for displaying a graph of a logical problem, which is the target problem before being converted so as to be implementable in a quantum computer.

According to the terminal device 200, the user (the person viewing the graph) can relatively easily confirm whether or not the relationship between the logical problem set and the obtained solution is appropriate. In particular, the user can visually grasp not only the coupling of two quantum bits in the logical problem, but also the coupling of three or more quantum bits, and confirm whether or not the relationship between the logical problem and the obtained solution is appropriate.

Furthermore, the display control unit 294 generates the data for displaying a graph representing the physical problem such that the graph shows a correspondence between physical bits, which are quantum bits used in the physical problem, and logical bits, which are quantum bits used in a logical problem serving as the target problem before being converted to the physical problem, in a representation method in which representation methods assigned to the logical bits are combined.

According to the terminal device 200, the user (the person viewing the graph) can relatively easily confirm the correspondence between the logical bits and the physical bits. For example, in a case where revising the implementation of a target problem on a quantum computer, the user can make reference to the correspondence between logical bits and physical bits shown in the graph.

Moreover, the display control device 294 generates the data for switchably displaying a plurality of combinations of values of quantum bits corresponding to one value of the parity node, in association with each of the variable nodes.

According to the terminal device 200, the user (the person viewing the display) can visually confirm and compare a plurality of combinations of quantum bit values corresponding to the values of the parity nodes in order. In this regard, it is expected that the user will be able to relatively easily obtain an appropriate combination of quantum bit values corresponding to the parity node values.

### Second Example Embodiment

FIG. 14 is a diagram showing a configuration example of a display control device according to at least one of the example embodiments. In the configuration shown in FIG. 14, a display control device 610 includes a display control unit 611.

With such a configuration, the display control unit 611 generates data for displaying variable nodes each indicating the state of at least three quantum bits, parity nodes indicating the parity of the at least three quantum bits, and edges connecting the variable nodes and the parity nodes.

The display control unit 611 corresponds to an example of the display control means.

According to the display control device 610, it is possible to represent the coupling of three or more quantum bits. In particular, according to the display control device 610, it is possible to represent the coupling of three or more quantum bits by indicating the parities of the three or more quantum bits and the edges linking the quantum bits and the parities.

### Third Example Embodiment

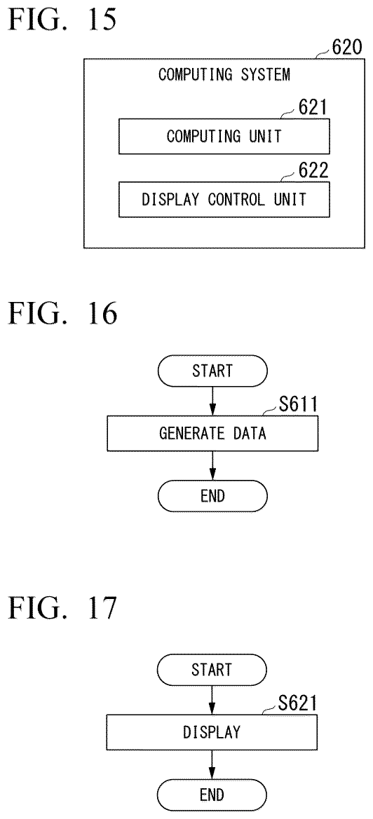

FIG. 15 is a diagram showing a configuration example of the computing system according to at least one of example embodiments. In the configuration shown in FIG. 15, a computing system 620 includes a computing unit 621 and a display control unit 622.

With such a configuration, the computing unit 621 performs a computation on a target problem serving as the target problem addressed by a quantum computer. The display control unit 622 generates data for displaying variable nodes each indicating the state of a plurality of quantum bits of the target problem, parity nodes indicating the parity of at least three quantum bits among the plurality of quantum bits, and edges coupling the variable nodes each indicating the state of at least those three quantum bits and the parity nodes.

The computing unit 621 corresponds to an example of the computing means. The display control unit 622 corresponds to an example of the display control means.

According to the computing system 620, it is possible to represent the coupling of three or more quantum bits. In particular, according to the computing system 620, it is possible to represent the coupling of three or more quantum bits by indicating the parities of the three or more quantum bits and the edges linking the quantum bits and the parities.

### Fourth Example Embodiment

FIG. 16 is a diagram showing an example of a processing procedure in a display control method according to at least one of the example embodiments. The display control method shown in FIG. 16 includes a step of generating data (Step S611).

In the step of generating data (Step S611), a computer generates data for displaying variable nodes each indicating a state of at least three quantum bits, parity nodes indicating a parity of at least those three quantum bits, and edges coupling the variable nodes and the parity nodes.

According to the display control method shown in FIG. 16, it is also possible to represent the coupling of three or more quantum bits. In particular, according to the display control method shown in FIG. 16, it is possible to represent the coupling of three or more quantum bits by indicating the parities of the three or more quantum bits and the edges linking the quantum bits and the parities.

### Fifth Example Embodiment

FIG. 17 is a diagram showing an example of a processing procedure in a display method according to at least one of the example embodiments. The display method shown in FIG. 17 includes a step of performing display (Step S621).

In the step of performing display (Step S621), a display device displays variable nodes each indicating a state of at least three quantum bits, parity nodes indicating a parity of at least those three quantum bits, and edges coupling the variable nodes and the parity nodes.

According to the display method shown in FIG. 17, it is also possible to represent the coupling of three or more quantum bits. In particular, according to the display method shown in FIG. 17, it is possible to represent the coupling of three or more quantum bits by indicating the parities of the three or more quantum bits and the edges linking the quantum bits and the parities.

### Sixth Example Embodiment

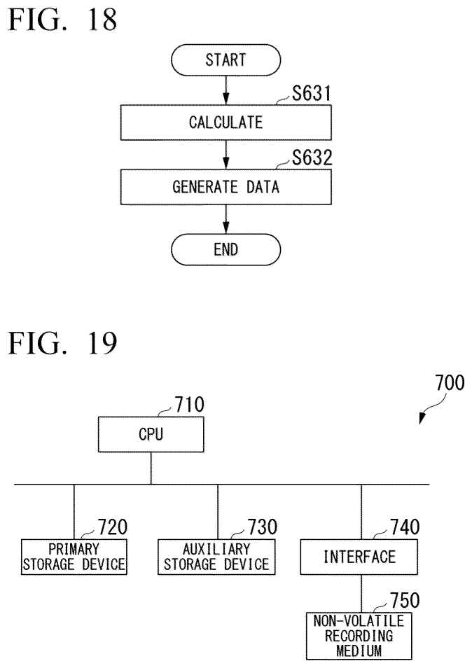

FIG. 18 is a diagram showing an example of a processing procedure in a computing method according to at least one of the example embodiments. The computing method shown in FIG. 18 includes a step of computing (Step S631) and a step of generating data (Step S632).

In the step of computing (Step S631), a computer performs a computation on a target problem serving as a target problem addressed by a quantum computer.

In the step of generating data (Step S632), a computer generates data for displaying variable nodes each indicating the state of a plurality of quantum bits of the target problem, parity nodes indicating the parity of at least three quantum bits among the plurality of quantum bits, and edges coupling the variable nodes and the parity nodes.

According to the computing method shown in FIG. 18, it is also possible to represent the coupling of three or more quantum bits. In particular, according to the computing method shown in FIG. 18, it is possible to represent the coupling of three or more quantum bits by indicating the parities of the three or more quantum bits and the edges linking the quantum bits and the parities.

FIG. 19 is a schematic block diagram showing a configuration of a computer according to at least one of example embodiments.

In the configuration shown in FIG. 19, a computer 700 includes a CPU 710, a primary storage device 720, an auxiliary storage device 730, an interface 740, and a non-volatile recording medium 750.

One or more of the computing system 1, the computing device 100, the terminal device 200, the display control device 610, and the computing system 620 or part thereof may be implemented in the computer 700. In such a case, operations of the respective processing units described above are stored in the auxiliary storage device 730 in the form of a program. The CPU 710 reads out the program from the auxiliary storage device 730, loads it on the primary storage device 720, and executes the processing described above according to the program. Moreover, the CPU 710 secures, according to the program, memory storage regions corresponding to the respective storage units mentioned above, in the primary storage device 720. Communication between each device and other devices is executed by the interface 740 having a communication function and communicating under the control of the CPU 710. The interface 740 also has a port for the non-volatile recording medium 750, and reads information from the non-volatile recording medium 750 and writes information to the non-volatile recording medium 750.

In the case where the computing system 1 is implemented in the computer 700, operations thereof are stored in the auxiliary storage device 730 in the form of a program. The CPU 710 reads out the program from the auxiliary storage device 730, loads it on the primary storage device 720, and executes the processes described above, according to the program.

Moreover, the CPU 710 secures a memory storage region in the primary storage device 720 for the processing to be performed by the computing system 1, according to the program. Communication with other devices performed by the computing system 1 is executed by the interface 740 having a communication function and operating under the control of the CPU 710. Interaction between the computing system 1 and the user is executed by the interface 740 having an input device and an output device, presenting information to the user through the output device under the control of CPU 710, and accepting user operations through the input device.

In the case where the computing device 100 is implemented in the computer 700, operations thereof are stored in the auxiliary storage device 730 in the form of a program. The CPU 710 reads out the program from the auxiliary storage device 730, loads it on the primary storage device 720, and executes the processes described above, according to the program.

Moreover, the CPU 710 secures a memory storage region in the primary storage device 720 for the processing to be performed by the computing device 100, according to the program. Communication with other devices performed by the computing device 100 is executed by the interface 740 having a communication function and operating under the control of the CPU 710. Interaction between the computing device 100 and the user is executed by the interface 740 having an input device and an output device, presenting information to the user through the output device under the control of the CPU 710, and accepting user operations through the input device.

In the case where the terminal device 200 is implemented in the computer 700, operations of the processing unit 290 and each component thereof are stored in the form of a program in the auxiliary storage device 730. The CPU 710 reads out the program from the auxiliary storage device 730, loads it on the primary storage device 720, and executes the processes described above, according to the program.

Also, the CPU 710 secures a memory storage region in the primary storage device 720 for the storage unit 280, according to the program. Communication with another device performed by the communication unit 210 is executed by the interface 740 having a communication function and operating under the control of the CPU 710. Display of images performed by the display unit 220 is executed by the interface 740 having a display device and displaying various images under the control of the CPU 710. User operations are accepted through the operation input unit 230 by the interface 740 having an input device and accepting user operations under control of the CPU 710.

In the case where the display control device 610 is implemented in the computer 700, operations of the display control unit 611 are stored in the auxiliary memory storage device 730 in the form of a program. The CPU 710 reads out the program from the auxiliary storage device 730, loads it on the primary storage device 720, and executes the processes described above, according to the program.

Moreover, the CPU 710 secures a memory storage region in the primary storage device 720 for the processing to be performed by the display control device 610, according to the program. Communication with other devices performed by the display control device 610 is executed by the interface 740 having a communication function and operating under the control of the CPU 710. Interaction between the display control device 610 and the user is executed by the interface 740 having an input device and an output device, presenting information to the user through the output device under the control of the CPU 710, and accepting user operations through the input device.

In the case where the computing system 620 is implemented in the computer 700, operations of the computing unit 621 and the display control unit 622 are stored in the auxiliary memory storage device 730 in the form of a program. The CPU 710 reads out the program from the auxiliary storage device 730, loads it on the primary storage device 720, and executes the processes described above, according to the program.

Moreover, the CPU 710 secures a memory storage region in the primary storage device 720 for the processing to be performed by the computing system 620, according to the program. Communication with other devices performed by the computing system 620 is executed by the interface 740 having a communication function and operating under the control of the CPU 710. Interaction between the computing system 620 and the user is executed by the interface 740 having an input device and an output device, presenting information to the user through the output device under the control of CPU 710, and accepting user operations through the input device.

Any one or more of the programs described above may be recorded in the non-volatile recording medium 750. In such a case, the interface 740 may read the program from the non-volatile recording medium 750. Then, the CPU 710 directly executes the program read by the interface 740, or it may be temporarily stored in the primary storage device 720 or the auxiliary storage device 730 and then executed.

It should be noted that programs for executing some or all of the processes to be performed using a classical computer among the processes performed by the computing system 1, the computing device 100, the terminal device 200, the display control device 610, and the computing system 620 may be recorded on a computer-readable recording medium, and the program recorded on the recording medium may be read into and executed on a computer system, to thereby perform the processing of each unit. The “computer system” here includes an OS (operating system) and hardware such as peripheral devices.

Moreover, the “computer-readable recording medium” referred to here refers to a portable medium such as a flexible disk, a magnetic optical disk, a ROM (Read Only Memory), and a CD-ROM (Compact Disc Read Only Memory), or a storage device such as a hard disk built in a computer system. The above program may be a program for realizing a part of the functions described above, and may be a program capable of realizing the functions described above in combination with a program already recorded in a computer system.

The example embodiments of the present disclosure have been described in detail with reference to the drawings. However, the specific configuration of the disclosure is not limited to the example embodiments, and may include designs and so forth that do not depart from the scope of the present disclosure.

While preferred example embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

The whole or part of the example embodiments disclosed above can be described as, but not limited to, the following supplementary notes.

### (Supplementary Note 1)

A display device comprising
a display control means that generates data for displaying
variable nodes each indicating a state of at least three quantum bits,
parity nodes indicating a parity of the at least three quantum bits, and
edges coupling the variable nodes and the parity nodes.

### (Supplementary Note 2)

The display control device according to supplementary note 1, wherein
the display control means generates the data for displaying variable nodes each indicating a state of a plurality of quantum bits in a target problem addressed by a quantum computer, and
the at least three quantum bits are included in the plurality of quantum bits.

### (Supplementary Note 3)

The display control device according to supplementary note 2, wherein
the display control means generates the data for displaying a graph such that setting values for the variable nodes and setting values for the parity nodes in the target problem are both represented by color, shading, or a combination thereof, and values of quantum bits indicated by the variable nodes and parities indicated by the parity nodes are both represented by an orientation of icons indicating nodes.

### (Supplementary Note 4)

The display control device according to supplementary note 2 or 3, wherein
the display control means generates the data for displaying a graph showing a physical problem, which is the target problem, converted so as to be implementable in a quantum computer.

### (Supplementary Note 5)

The information generation device according to any one of supplementary notes 2 to 4, wherein
the display control means generates the data for displaying a graph showing a logical problem, which is the target problem, before being converted so as to be implementable in a quantum computer.

### (Supplementary Note 6)

The information generation device according to supplementary note 4, wherein
the display control means generates the data for displaying a graph representing the physical problem such that the graph shows a correspondence between physical bits, which are quantum bits used in the physical problem, and logical bits, which are quantum bits used in a logical problem, in a representation method in which representation methods assigned to the logical bits are combined.

### (Supplementary Note 7)

The display control device according to any one of supplementary notes 1 to 6, wherein
the display control means generates the data for switchably displaying a plurality of combinations of values of the quantum bits corresponding to one value of the parity node, in association with each of the variable nodes.

### (Supplementary Note 8)

A computing system comprising:
a computing means that performs a computation on a target problem serving as a target problem addressed by a quantum computer; and a display control means, wherein
the display control means generates data for displaying
variable nodes each indicating a state of a plurality of quantum bits of the target problem,
parity nodes indicating a parity of at least three quantum bits among the plurality of quantum bits, and
edges coupling the variable nodes each indicating a state of the at least three quantum bits and the parity nodes.

### (Supplementary Note 9)

The computing system according to supplementary note 8, wherein
the display control means generates the data for displaying a graph such that setting values for the variable nodes and setting values for the parity nodes in the target problem are both represented by color, shading, or a combination thereof, and values of quantum bits indicated by the variable nodes and parities indicated by the parity nodes are both represented by an orientation of icons indicating nodes.

### (Supplementary Note 10)

The computing system according to supplementary note 8 or 9, wherein
the display control means generates the data for displaying a graph of a physical problem, which is the target problem, converted so as to be implementable in a quantum computer.

### (Supplementary Note 11)

The computing system according to any one of supplementary notes 8 to 10, wherein
the display control means generates the data for displaying a graph of a logical problem, which is the target problem, before being converted so as to be implementable in a quantum computer.

### (Supplementary Note 12)

The computing system according to supplementary note 10, wherein
the display control means generates the data for displaying a graph representing the physical problem such that the graph shows a correspondence between physical bits, which are quantum bits used in the physical problem, and logical bits, which are quantum bits used in a logical problem, in a representation method in which representation methods assigned to the logical bits are combined.

### (Supplementary Note 13)

The computing system according to any one of supplementary notes 8 to 12, wherein
the display control means generates the data for switchably displaying a plurality of combinations of values of the quantum bits corresponding to one value of the parity node, in association with each of the variable nodes.

### (Supplementary Note 14)

A display control method comprising
a computer-implemented step of generating data for displaying
variable nodes each indicating a state of at least three quantum bits,
parity nodes indicating a parity of the at least three quantum bits, and
edges coupling the variable nodes and the parity nodes.

### (Supplementary Note 15)

The display control method according to supplementary note 14, wherein
the step of generating the data includes a step of, by means of the computer, generating the data for displaying variable nodes each indicating a state of a plurality of quantum bits in a target problem addressed by a quantum computer, and
the at least three quantum bits are included in the plurality of quantum bits.

### (Supplementary Note 16)

The display control method according to supplementary note 15, wherein
the step of generating the data includes a step of, by means of the computer, generating the data for displaying a graph such that setting values for the variable nodes and setting values for the parity nodes in the target problem are both represented by color, shading, or a combination thereof, and values of quantum bits indicated by the variable nodes and parities indicated by the parity nodes are both represented by an orientation of icons indicating nodes.

### (Supplementary Note 17)

The display control method according to supplementary note 15 or 16, wherein
the step of generating the data includes a step of, by means of the computer, generating the data for displaying a graph showing a physical problem, which is the target problem, converted so as to be implementable in a quantum computer.

### (Supplementary Note 18)

The display control method according to any one of supplementary notes 15 to 17, wherein
the step of generating the data includes a step of, by means of the computer, generating the data for displaying a graph of a logical problem, which is the target problem, before being converted so as to be implementable in a quantum computer.

### (Supplementary Note 19)

The display control method according to supplementary note 17, wherein
the step of generating the data includes a step of, by means of the computer, generating the data for displaying a graph representing the physical problem such that the graph shows a correspondence between physical bits, which are quantum bits used in the physical problem, and logical bits, which are quantum bits used in a logical problem, in a representation method in which representation methods assigned to the logical bits are combined.

### (Supplementary Note 20)

The display control method according to any one of supplementary notes 14 to 19, wherein
the step of generating the data includes a step of, by means of the computer, generating the data for switchably displaying a plurality of combinations of values of the quantum bits corresponding to one value of the parity node, in association with each of the variable nodes.

### (Supplementary Note 21)

A display method comprising
a step, by means of a display device, of displaying
variable nodes each indicating a state of at least three quantum bits,
parity nodes indicating a parity of the at least three quantum bits, and
edges coupling the variable nodes and the parity nodes.

### (Supplementary Note 22)

The display method according to supplementary note 21, wherein
the step of displaying includes a step of, by means of the display device, displaying variable nodes each indicating a state of a plurality of quantum bits in a target problem addressed by a quantum computer, and the at least three quantum bits are included in the plurality of quantum bits.

### (Supplementary Note 23)

The display method according to supplementary note 22, wherein
the step of displaying includes a step of, by means of the display device, displaying a graph such that setting values for the variable nodes and setting values for the parity nodes in the target problem are both represented by color, shading, or a combination thereof, and values of quantum bits indicated by the variable nodes and parities indicated by the parity nodes are both represented by an orientation of icons indicating nodes.

### (Supplementary Note 24)

The display method according to supplementary note 22 or 23, wherein
the step of displaying includes a step of, by means of the display device, displaying a graph of a physical problem, which is the target problem, converted so as to be implementable in a quantum computer.

### (Supplementary Note 25)

The display method according to any one of supplementary notes 22 to 24, wherein
the step of displaying includes a step of, by means of the display device, displaying a graph of a logical problem, which is the target problem, before being converted so as to be implementable in a quantum computer.

### (Supplementary Note 26)

The display method according to supplementary note 24, wherein
the step of displaying includes a step of, by means of the display device, displaying a graph representing the physical problem such that the graph shows a correspondence between physical bits, which are quantum bits used in the physical problem, and logical bits, which are quantum bits used in a logical problem, in a representation method in which representation methods assigned to the logical bits are combined.

### (Supplementary Note 27)

The display method according to any one of supplementary notes 21 to 26, wherein
the step of displaying includes a step of, by means of the display device, switchably displaying a plurality of combinations of values of the quantum bits corresponding to one value of the parity node, in association with each of the variable nodes.

### (Supplementary Note 28)

A computing method comprising
steps of, by means of a computing system,
performing a computation on a target problem serving as a target problem addressed by a quantum computer, and generating data for displaying
variable nodes each indicating a state of a plurality of quantum bits of the target problem,
parity nodes indicating a parity of at least three quantum bits among the plurality of quantum bits, and
edges coupling the variable nodes each indicating a state of the at least three quantum bits and the parity nodes.

### (Supplementary Note 29)

The computing method according to supplementary note 28, wherein
the step of generating the data includes a step of, by means of the computing system, generating the data for displaying a graph such that setting values for the variable nodes and setting values for the parity nodes in the target problem are both represented by color, shading, or a combination thereof, and values of quantum bits indicated by the variable nodes and parities indicated by the parity nodes are both represented by an orientation of icons indicating nodes.

### (Supplementary Note 30)

The computing method according to supplementary note 28 or 29, wherein
the step of generating the data includes a step of, by means of the computing system, generating the data for displaying a graph of a physical problem, which is the target problem, converted so as to be implementable in a quantum computer.

### (Supplementary Note 31)

The display method according to any one of supplementary notes 28 to 30, wherein
the step of generating the data includes a step of, by means of the computing system, generating the data for displaying a graph of a logical problem, which is the target problem, before being converted so as to be implementable in a quantum computer.

### (Supplementary Note 32)

The computing method according to supplementary note 30, wherein
the step of generating the data includes a step of, by means of the computing system, generating the data for displaying a graph representing the physical problem such that the graph shows a correspondence between physical bits, which are quantum bits used in the physical problem, and logical bits, which are quantum bits used in a logical problem, in a representation method in which representation methods assigned to the logical bits are combined.

### (Supplementary Note 33)

The computing method according to any one of supplementary notes 28 to 32, wherein
the step of generating the data includes a step of, by means of the computing system, generating the data for switchably displaying a plurality of combinations of values of the quantum bits corresponding to one value of the parity node, in association with each of the variable nodes.

### (Supplementary Note 34)

A program that causes a computer to execute a step of generating data for displaying
variable nodes each indicating a state of at least three quantum bits,
parity nodes indicating a parity of the at least three quantum bits, and
edges coupling the variable nodes and the parity nodes.

### (Supplementary Note 35)

The program according to supplementary note 34, wherein
in the step of generating the data, the program causes the computer to execute a step of performing control for displaying variable nodes each indicating a state of a plurality of quantum bits in a target problem addressed by a quantum computer, and at least three quantum bits are included in the plurality of quantum bits.

### (Supplementary Note 36)

The program according to supplementary note 35, wherein
in the step of generating the data, the program causes the computer to execute generation of data for displaying a graph such that setting values for the variable nodes and setting values for the parity nodes in the target problem are both represented by color, shading, or a combination thereof, and values of quantum bits indicated by the variable nodes and parities indicated by the parity nodes are both represented by an orientation of icons indicating nodes.

### (Supplementary Note 37)

The program according to supplementary note 35 or 36, wherein
in the step of generating the data, the program causes the computer to execute generation of data for displaying a graph of a physical problem, which is the target problem, converted so as to be implementable in a quantum computer.

### (Supplementary Note 38)

The program according to any one of supplementary notes 35 to 37, wherein
in the step of generating the data, the program causes the computer to execute generation of data for displaying a graph of a logical problem, which is the target problem, before being converted so as to be implementable in a quantum computer.

### (Supplementary Note 39)

The program according to supplementary note 37, wherein
in the step of generating the data, the program causes the computer to execute generation of the data for displaying a graph representing the physical problem such that the graph shows a correspondence between physical bits, which are quantum bits used in the physical problem, and logical bits, which are quantum bits used in a logical problem, in a representation method in which representation methods assigned to the logical bits are combined.

### (Supplementary Note 40)

The program according to any one of supplementary notes 34 to 39, wherein
in the step of generating the data, the program causes the computer to execute generation of the data for switchably displaying a plurality of combinations of values of the quantum bits corresponding to one value of the parity node, in association with each of the variable nodes.

What is claimed is:

1. A display control device comprising:
at least one memory configured to store instructions; and
at least one processor configured to execute the instructions to generate data for displaying:
at least three variable nodes, wherein each variable node indicates a state of each of at least three quantum bit;
parity node indicating a parity of the at least three quantum bits; and
edges coupling between each variable nodes and the parity node.

2. The display control device according to claim 1, wherein the at least one processor is configured to execute the instructions to generate the data for displaying variable nodes each indicating a state of a plurality of quantum bits in a target problem addressed by a quantum computer, and
the at least three quantum bits are included in the plurality of quantum bits.

3. The display control device according to claim 2, wherein the at least one processor is configured to execute the instructions to generate the data for displaying a graph showing a physical problem, which is the target problem, converted so as to be implementable in a quantum computer.

4. The display control device according to claim 2, wherein the at least one processor is configured to execute the instructions to generate the data for displaying a graph showing a logical problem, which is the target problem, before being converted so as to be implementable in a quantum computer.

5. The display control device according to claim 3, wherein the at least one processor is configured to execute the instructions to generate the data for displaying a graph representing the physical problem such that the graph shows a correspondence between physical bits, which are quantum bits used in the physical problem, and logical bits, which are quantum bits used in a logical problem serving as the target problem before being converted to the physical problem, in a representation method in which representation methods assigned to the logical bits are combined.

6. The display control device according to claim 1, wherein the at least one processor is configured to execute the instructions to generate the data for switchably displaying a plurality of combinations of values of the quantum bits corresponding to one value of the parity node, in association with each of the variable nodes.

7. A computing system comprising:
at least one memory configured to store instructions; and
at least one processor configured to execute the instructions to:
perform a computation on a target problem serving as a target problem addressed by a quantum computer; and
generate data for displaying:
at least three variable nodes, wherein each variable node indicates a state of each of at least three quantum bits among a plurality of quantum bits of the target problem;
parity node indicating a parity of the at least three quantum bits among the plurality of quantum bits; and
edges coupling between each variable nodes indicating the state of each of at least three quantum bits and the parity node.

8. The computing system according to claim 7, wherein the at least one processor is configured to execute the instructions to generate the data for displaying a graph such that setting values for the variable nodes and setting values for the parity nodes in the target problem are both represented by color, shading, or a combination thereof, and values of quantum bits indicated by the variable nodes and parities indicated by the parity nodes are both represented by an orientation of icons indicating nodes.

9. The computing system according to claim 7, wherein the at least one processor is configured to execute the instructions to generate the data for displaying a graph of a physical problem, which is the target problem, converted so as to be implementable in a quantum computer.

10. The computing system according to claim 7, wherein the at least one processor is configured to execute the instructions to generate the data for displaying a graph of a logical problem, which is the target problem, before being converted so as to be implementable in a quantum computer.

11. The computing system according to claim 9, wherein the at least one processor is configured to execute the instructions to generate the data for displaying a graph representing the physical problem such that the graph shows a correspondence between physical bits, which are quantum bits used in the physical problem, and logical bits, which are quantum bits used in a logical problem, in a representation method in which representation methods assigned to the logical bits are combined.

12. The computing system according to claim 7, wherein the at least one processor is configured to execute the instructions to generate the data for switchably displaying a plurality of combinations of values of the quantum bits corresponding to one value of the parity node, in association with each of the variable nodes.

13. A display control method comprising:
generating data for displaying:
at least three variable nodes, wherein each variable node indicates a state of each of at least three quantum bits;
parity node indicating a parity of the at least three quantum bits; and
edges coupling between each variable nodes and the parity node.

14. The display control method according to claim 13, wherein generating the data includes generating the data for displaying variable nodes each indicating a state of a plurality of quantum bits in a target problem addressed by a quantum computer, and
the at least three quantum bits are included in the plurality of quantum bits.

15. The display control device according to claim 14, wherein generating the data includes generating the data for displaying a graph such that setting values for the variable nodes and setting values for the parity nodes in the target problem are both represented by color, shading, or a combination thereof, and values of quantum bits indicated by the variable nodes and parities indicated by the parity nodes are both represented by an orientation of icons indicating nodes.

16. The display control method according to claim 14, wherein generating the data includes generating the data for displaying a graph showing a physical problem, which is the target problem, converted so as to be implementable in a quantum computer.

17. The display control method according to claim 14, wherein generating the data includes generating the data for displaying a graph of a logical problem, which is the target problem, before being converted so as to be implementable in a quantum computer.

18. The display control method according to claim 16, wherein generating the data includes generating the data for displaying a graph representing the physical problem such that the graph shows a correspondence between physical bits, which are quantum bits used in the physical problem, and logical bits, which are quantum bits used in a logical problem, in a representation method in which representation methods assigned to the logical bits are combined.

19. The display control method according to claim 13, wherein generating the data includes generating the data for switchably displaying a plurality of combinations of values of the quantum bits corresponding to one value of the parity node, in association with each of the variable nodes.
